(19) United States
(12) Patent Application Publication
(10) Pub. No.: US 2019/0363432 A1
(43) Pub. Date: Nov. 28, 2019

(54) PLANAR ANTENNA

(71) Applicant: HITACHI METALS, LTD., Minato-ku, Tokyo (JP)

(72) Inventors: Kenji HAYASHI, Minato-ku, Tokyo (JP); Masato ENOKI, Minato-ku, Tokyo (JP); Hatsuo IKEDA, Minato-ku, Tokyo (JP)

(21) Appl. No.: 16/484,139

(22) PCT Filed: Feb. 8, 2018
(86) PCT No.: PCT/JP2018/004443

§ 371 Date: Aug. 7, 2019

(30) Foreign Application Priority Data
Feb. 13, 2017 (JP) 2017-023977

(51) Int. Cl. H01Q 1/38; H01Q 9/04; B32B 18/00; B32B 3/26; B28B 11/24

(52) U.S. Cl. CPC H01Q 1/38; H01Q 9/0407; B32B 18/00; B32B 2457/00; B28B 11/243; B32B 2307/202; B32B 2307/204; B32B 3/266

(57) ABSTRACT

A planar antenna includes a multilayer ceramic body 10 having an upper surface and a lower surface, and including a plurality of ceramic layers stacked together, at least one radiation conductor 31 positioned at one of interfaces between the plurality of ceramic layers in the multilayer ceramic body or on the upper surface of the multilayer ceramic body, a ground conductor 32 positioned at another one of the interfaces between the plurality of ceramic layers in the multilayer ceramic body or on the lower surface of the multilayer ceramic body, and a low-dielectric-constant region 115 positioned in the multilayer ceramic body between the radiation conductor and the ground conductor, and having a plurality of hollow portions.

### TECHNICAL FIELD

The present application relates to planar antennas, co-fired ceramic substrates, radio communication modules, and production methods for co-fired ceramic substrates.

### BACKGROUND ART

The amount of information communicated over the Internet has been dramatically increasing, and there has been a demand for radio communication techniques capable of propagating a large volume of information. There also has been a demand for television broadcasting of higher-definition images.

In radio communication, the higher the carrier frequency, the broader the frequency band that can be allocated for information communication, i.e. a large amount of information can be propagated. Therefore, microwave radio communication, particularly in the range of about 1 GHz to about 30 GHz, has in recent years been widely used, including wireless LAN, mobile telephone communication networks, satellite communication, etc.

Among the antennas used in such high-frequency radio communication is, for example, a planar antenna. Patent Document 1 discloses a planar antenna for a GPS reception system in which an antenna conductor is provided on a printed wiring board. The antenna conductor is covered with a solder resist for corrosion prevention. Patent Document 2 discloses a planar antenna for microwave and millimeter wave-range communication systems in which a conductor film and a protective film covering the conductor film are provided on a resin substrate.

### CITATION LIST

### Patent Literature

Patent Document No. 1: Japanese Laid-Open Patent Publication No. H06-140831
Patent Document No. 2: Japanese Laid-Open Patent Publication No. 2012-054826

### SUMMARY OF INVENTION

### Technical Problem

In recent years, as short-range radio communication techniques for propagating a larger volume of information, for example, quasi-millimeter wave/millimeter wave band radio communication techniques have attracted attention.

A non-limiting example embodiment of the present application provides a planar antenna, co-fired ceramic substrate, and quasi-microwave/centimeter wave/quasi-millimeter wave/millimeter wave radio communication module that can be used in quasi-microwave/centimeter wave/quasi-millimeter wave/millimeter wave band radio communication.

### Solution to Problem

A planar antenna of the present disclosure includes a multilayer ceramic body having an upper surface and a lower surface, and including a plurality of ceramic layers stacked together, at least one radiation conductor positioned at one of interfaces between the plurality of ceramic layers in the multilayer ceramic body or on the upper surface of the multilayer ceramic body, a ground conductor positioned at another one of the interfaces between the plurality of ceramic layers in the multilayer ceramic body or on the lower surface of the multilayer ceramic body, and a low-dielectric-constant region positioned in the multilayer ceramic body between the radiation conductor and the ground conductor, and having a plurality of hollow portions.

A co-fired ceramic substrate of the present disclosure includes a multilayer ceramic body having an upper surface and a lower surface, and including a plurality of ceramic layers stacked together, at least one radiation conductor positioned at one of interfaces between the plurality of ceramic layers in the multilayer ceramic body or on the upper surface of the multilayer ceramic body, a ground conductor positioned at another one of the interfaces between the plurality of ceramic layers in the multilayer ceramic body or on the lower surface of the multilayer ceramic body, a low-dielectric-constant region positioned in the multilayer ceramic body between the radiation conductor and the ground conductor, and having a plurality of hollow portions, a plurality of conductor patterns positioned at another interface that is between the plurality of ceramic layers and is positioned closer the lower surface than is the radiation conductor, and a plurality of conductive vias provided in a ceramic layer of the plurality of ceramic layer that is positioned closer to the lower surface than is the radiation conductor. The radiation conductor, the ground conductor, and a portion of the plurality of ceramic layers positioned between the radiation conductor and the ground conductor form a planar antenna. The plurality of conductor patterns and the plurality of conductive vias form a passive component and an interconnect.

As viewed from above the multilayer ceramic body, an outer edge of the low-dielectric-constant region may surround the entire radiation conductor.

As viewed from above the multilayer ceramic body, an outer edge of the ground conductor may surround the entire radiation conductor.

The radiation conductor may be positioned on the upper surface of the multilayer ceramic body.

The plurality of hollow portions may be a plurality of through holes provided in at least one ceramic layer of the plurality of ceramic layers.

The plurality of hollow portions may be a plurality of through holes provided in each of two or more adjacent ceramic layers of the plurality of ceramic layers, and the plurality of through holes formed in the two or more respective ceramic layers may be aligned in a stacking direction of the two or more ceramic layers.

The plurality of through holes may be arranged in two directions or in a staggered pattern in a plane perpendicular to the stacking direction.

The plurality of hollow portions may be a plurality of through holes provided in each of two or more adjacent ceramic layers of the plurality of ceramic layers, and positions of the plurality of through holes may be different between two adjacent ceramic layers.

The plurality of hollow portions may be a plurality of through holes provided in each of two or more ceramic layers of the plurality of ceramic layers, and a ceramic layer in which a through hole is not formed may be positioned between the two or more ceramic layers.

The plurality of hollow portions may be provided in at least one ceramic layer of the plurality of ceramic layer, and may be a space that does not penetrate through the ceramic layer.

In the planar antenna, there may be a plurality of the radiation conductors.

As viewed from above the multilayer ceramic body, an outer edge of the low-dielectric-constant region may surround the entire radiation conductor.

A quasi-microwave/centimeter wave/quasi-millimeter wave/millimeter wave radio communication module of the present disclosure include any of the above co-fired ceramic substrates, and an active component coupled to the plurality of electrodes positioned on the lower surface of the multilayer ceramic body.

A method for producing a co-fired ceramic substrate of the present disclosure, includes a step (A) of preparing a plurality of ceramic green sheets including a first ceramic green sheet on which a conductive paste pattern of a radiation conductor is disposed, a second ceramic green sheet on which a conductive paste pattern of a ground conductor is disposed, and at least one third ceramic green sheet including a region in which a plurality of through holes are formed, a step (B) of stacking the plurality of ceramic green sheets together and joining the plurality of ceramic green sheets together by pressing such that the conductive paste pattern of the radiation conductor of the first ceramic green sheet is positioned above or below the region of the at least one third ceramic green sheet, and the at least one third ceramic green sheet is positioned between the first ceramic green sheet and the second ceramic green sheet, to obtain a green sheet laminate, and a step (C) of heating the green sheet laminate to sinter the green sheet laminate.

The method may further include a step of, between the step (A) and the step (B), filling the plurality of through holes of the at least one third ceramic green sheet with a paste containing an organic resin. In the step (C), the paste containing the organic resin may be caused to disappear due to the heating.

Another method for producing a co-fired ceramic substrate of the present disclosure, includes a step (A) of preparing a plurality of ceramic green sheets including a first ceramic green sheet on which a conductive paste pattern of a radiation conductor is disposed, a second ceramic green sheet on which a conductive paste pattern of a ground conductor is disposed, and at least one third ceramic green sheet including a region in which a plurality of microcapsules of an organic material are disposed, a step (B) of stacking the plurality of ceramic green sheets together and joining the plurality of ceramic green sheets together by pressing such that the conductive paste pattern of the radiation conductor of the first ceramic green sheet is positioned above or below the region of the at least one third ceramic green sheet, and the at least one third ceramic green sheet is positioned between the first ceramic green sheet and the second ceramic green sheet, to obtain a green sheet laminate, and a step (C) of heating the green sheet laminate to cause a binder and the microcapsules to disappear from the green sheet laminate, and sinter the green sheet laminate.

### Advantageous Effects of Invention

According to the embodiment of the present disclosure, a planar antenna applicable to quasi-microwave/centimeter wave/quasi-millimeter wave/millimeter wave band radio communication, and a co-fired ceramic substrate and a quasi-microwave/centimeter wave/quasi-millimeter wave/millimeter wave radio communication module that include the planar antenna, are provided. A production method for a co-fired ceramic substrate including the planar antenna is also provided.

### BRIEF DESCRIPTION OF DRAWINGS

FIGS. 1(a), 1(b), and 1(c) are a schematic top view, a schematic bottom view, and a cross-sectional view taken along line 1c-1c of FIG. 1(b) showing an example of a first embodiment of a co-fired ceramic substrate.

FIG. 2 is a schematic top view of the co-fired ceramic substrate of FIG. 1, together with hollow spaces and a ground conductor.

FIGS. 3(a) to 3(f) are cross-sectional views showing another example arrangement of a radiation conductor and a ground conductor of a co-fired ceramic substrate.

FIGS. 4(a) to 4(f) are cross-sectional views showing steps of an embodiment of a production method for a co-fired ceramic substrate.

FIG. 5(a) is a schematic cross-sectional view showing a cross-section of a planar antenna of an example of a second embodiment of a co-fired ceramic substrate, FIG. 5(b) is a top view of a low-dielectric-constant region positioned in a multilayer ceramic body, FIG. 5(c) is another top view of a low-dielectric-constant region positioned in a multilayer ceramic body, and FIG. 5(d) is a cross-sectional view of the low-dielectric-constant region taken along 5d-5d of FIG. 5(b).

FIG. 6(a) is a top view of a low-dielectric-constant region positioned in a multilayer ceramic body of another example of the second embodiment of a co-fired ceramic substrate, FIG. 6(b) is a cross-sectional view of the low-dielectric-constant region taken along line 6b-6b of FIG. 6(a), and FIGS. 6(c) and 6(d) are top views of a ceramic layer included in a low-dielectric-constant region.

FIG. 7(a) is a top view of a low-dielectric-constant region positioned in a multilayer ceramic body of another example of the second embodiment of a co-fired ceramic substrate, FIG. 7(b) is a cross-sectional view of the low-dielectric-constant region taken along line 7b-7b of FIG. 7(a), and FIGS. 7(c) and 7(d) are top views of a ceramic layer included in a low-dielectric-constant region.

FIG. 8(a) is a schematic cross-sectional view showing a planar antenna of another example of the second embodiment of a co-fired ceramic substrate, and FIG. 8(b) is a cross-sectional view of a ceramic layer included in a low-dielectric-constant region.

FIGS. 9(a) and 9(b) are a bottom view and a schematic cross-sectional view showing an embodiment of quasi-millimeter wave/millimeter wave band radio communication.

FIGS. 10(a) and 10(b) are a cross-sectional view and a top view showing a structure of a planar antenna used in experimental examples.

FIG. 11 is a graph showing a result of Experimental Example 1.

FIG. 12 is a graph showing a result of Experimental Example 3.

FIGS. 13(a) to 13(d) are cross-sectional views showing steps of an example of a production method for a co-fired ceramic substrate of the second embodiment.

FIG. 14 is a diagram showing a structure used in calculation of Experimental Example 4.

FIG. 15 is a graph showing a result of Experimental Example 4.

FIG. 16 is a graph showing a result of Experimental Example 4.

FIG. 17 is a graph showing a result of Experimental Example 4.

FIG. 18 is a graph showing a result of Experimental Example 4.

FIG. 19 is a graph showing a result of Experimental Example 4.

### DESCRIPTION OF EMBODIMENTS

The present inventors have extensively studied planar antennas that can be used in quasi-microwave/centimeter wave/quasi-millimeter wave/millimeter wave band radio communication. In quasi-microwave band radio communication, radio waves having a wavelength of 10 cm to 30 cm and a frequency of 1 GHz to 3 GHz are used as carrier waves. In centimeter wave band radio communication, radio waves having a wavelength of 1 cm to 10 cm and a frequency of 3 GHz to 30 GHz are used as carrier waves. In millimeter wave band radio communication, radio waves having a wavelength of 1 mm to 10 mm and a frequency of 30 GHz to 300 GHz are used as carrier waves. In quasi-millimeter wave band radio communication, radio waves having a wavelength of 10 mm to 30 mm and a frequency of 10 GHz to 30 GHz are used as carrier waves. In quasi-microwave/centimeter wave/quasi-millimeter wave/millimeter wave band radio communication, planar antennas have a size of several centimeters or sub-millimeters. Therefore, for example, in the case where a quasi-microwave/centimeter wave/quasi-millimeter wave/millimeter wave radio communication circuit is constructed using a multilayer ceramic fired substrate, a planar antenna can be implemented on the multilayer ceramic fired substrate.

Meanwhile, for example, a quasi-millimeter wave/millimeter wave band radio communication circuit is significantly affected by transmission loss. A loss α caused by a dielectric material that occurs due to conversion of radio waves transmitted in radio communication into heat is represented by expression (1). In expression (1), f represents the frequency of carrier waves, εᵣ represents the relative dielectric constant of the dielectric material, and tan δ represents the dielectric loss tangent of the dielectric material. As can be seen from expression (1), the loss α caused by the dielectric material is proportional to tan δ, and is proportional the (½)th power of εᵣ, and the loss α decreases with a decrease in tan δ and εᵣ.

α∂f·∞(εᵣ)·tan δ (1)

εᵣ and tan δ are physical properties of a ceramic material contained in the multilayer ceramic fired substrate. When the composition and firing conditions of the ceramic are adjusted, both of εᵣ and tan δ cannot always be simultaneously reduced. The present inventors have arrived at a novel planar antenna that is provided on a co-fired ceramic fired substrate and in which εᵣ can be structurally adjusted. An embodiment of a planar antenna, co-fired ceramic substrate, and quasi-microwave/centimeter wave/quasi-millimeter wave/millimeter wave radio communication module according to the present disclosure will now be described in detail.

### First Embodiment

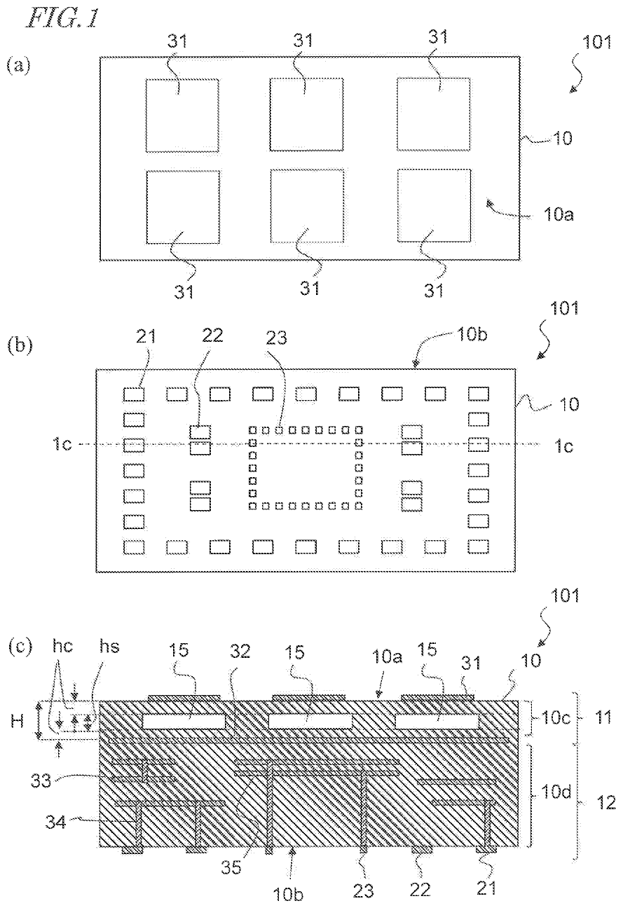

A first embodiment of a planar antenna and a co-fired ceramic substrate will be described. FIGS. 1(a) and 1(b) are schematic top and bottom views of a co-fired ceramic substrate 101 according to the first embodiment of the present disclosure. FIG. 1(c) is a cross-sectional view of the co-fired ceramic substrate 101 taken along line 1c-1c of FIG. 1(b).

[1. Structures of Planar Antenna and Co-Fired Ceramic Substrate]

The co-fired ceramic substrate 101 includes a multilayer ceramic body 10, hollow spaces 15 provided in the multilayer ceramic body 10, at least one radiation conductor 31, and a ground conductor 32.

The multilayer ceramic body 10 has an upper surface 10a and a lower surface 10b. The multilayer ceramic body 10 has a plurality of ceramic layers obtained by stacking green sheets together and firing the green sheets. In the multilayer ceramic body 10, there may be no clear interface between the plurality of ceramic layers. Each ceramic layer corresponds to one green sheet.

The radiation conductor 31 is positioned on the upper surface 10a or at one of the interfaces between the plurality of ceramic layers. The ground conductor 32 is positioned at another one of the interfaces between the plurality of ceramic layers that is closer to the lower surface 10b than is the radiation conductor 31, or on the lower surface 10b. In FIG. 1, the radiation conductor 31 is positioned on the upper surface 10a, and the ground conductor 32 is positioned in the multilayer ceramic body 10, closer to the lower surface 10b than is the radiation conductor 31.

The plurality of ceramic layers of the multilayer ceramic body 10 include a first portion 10c positioned between the upper surface 10a and the ground conductor 32, and a second portion 10d positioned between the lower surface 10b and the ground conductor 32. The first portion 10c includes the hollow spaces 15. As shown in FIG. 1(c), the radiation conductor 31, the first portion 10c including the hollow spaces 15 of the multilayer ceramic body 10, and the ground conductor 32 constitute a planar antenna 11. The planar antenna 11 is a patch antenna in this embodiment, and is a microstrip antenna including the radiation conductor 31, the ground conductor 32, and one or more ceramic layers interposed between the radiation conductor 31 and the ground conductor 32.

The radiation conductor 31 is a radiation element that radiates radio waves, and is formed of a conductive layer. As shown in FIG. 1(a), in this embodiment, the radiation conductor 31 has a rectangular (square) shape. However, the radiation conductor 31 may have a circular shape or other shapes. In this embodiment, the planar antenna 11 includes six radiation conductors 31, which are two-dimensionally arranged on the upper surface 10a. The radiation conductors 31 may be two-dimensionally arranged in the same interface of the interfaces between the plurality of ceramic layers. The plurality of radiation conductors 31 constitute an array antenna, which enhances the directivity of radio waves that are radiated or received. For example, in the case where the shape of the radiation conductor 31 is rectangular, the length of a side of the radiation conductor 31 is ½ of the wavelength of carrier waves, and for example, 5 mm or less in the case of millimeter waves.

The hollow spaces 15 are positioned between the respective radiation conductors 31 on the upper surface 10a and the ground conductor 32. The hollow spaces 15 are a space that is not filled with the ceramic material included in the multilayer ceramic body 10 or any other solid or liquid material. The hollow spaces 15 are filled with the atmosphere or a gas filling an ambient gas during firing. The hollow spaces 15 may be in communication with the outside of the multilayer ceramic body 10, or may be a space isolated from the outside.

The ground conductor 32 functions as a ground for the microstrip antenna, and is formed of a conductive layer.

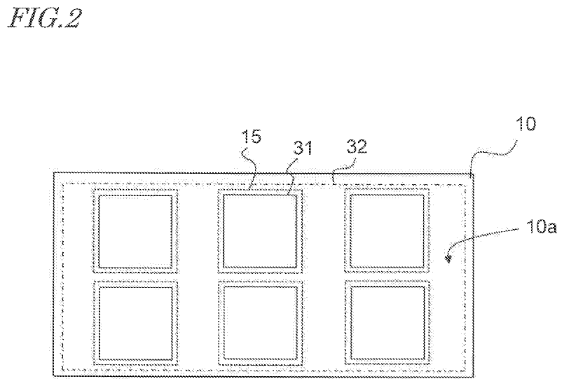

FIG. 2 is a top view of the co-fired ceramic substrate 101, indicating the hollow spaces 15 and the ground conductor 32 by dashed lines and a dash-dot line, respectively. As shown in FIG. 2, in a top view the upper surface 10a, the outer edge of each hollow space 15 completely surrounds the corresponding radiation conductor 31. In other words, each radiation conductor 31 is preferably entirely positioned in the region of the corresponding hollow space 15 in the stacking direction of the multilayer ceramic body 10. In addition, in a top view, the outer edge of the ground conductor 32 preferably completely surround the entire array of the radiation conductors 31. In other words, the radiation conductors 31 are all positioned in the region of the ground conductor 32 in the stacking direction of the multilayer ceramic body 10. In this embodiment, the ground conductor 32 has a greater size than that of the entire array of the radiation conductors 31. Alternatively, the planar antenna 11 may include six ground conductors 32. In that case, in a top view, the outer edge of each ground conductor 32 preferably completely surrounds the corresponding radiation conductor 31. In other words, each radiation conductor 31 is preferably entirely positioned in the region of the corresponding ground conductor 32 in the stacking direction of the multilayer ceramic body 10.

As shown in FIG. 1(c), in the planar antenna 11, the relative dielectric constant of the material positioned between the radiation conductors 31 and the ground conductor 32 affects the radiation efficiency of the planar antenna 11. As indicated by expression (1), the loss α caused by the dielectric material of the planar antenna 11 is proportional to the (½)th power of the relative dielectric constant εᵣ, and the loss α decreases with a decrease in εᵣ. In the planar antenna 11, the hollow spaces 15 are positioned between the radiation conductors 31 and the ground conductor 32, and the gas filling the hollow spaces 15 is about 1 irrespective of the type and composition. In contrast to this, the relative dielectric constant of the ceramic material included in the multilayer ceramic body 10 is, for example, about 3 to about 15. Therefore, the effective relative dielectric constant between the radiation conductors 31 and the ground conductor 32 is smaller than when the hollow spaces 15 are not provided. In other words, the planar antenna 11 can inhibit the loss caused by the dielectric material, due to the presence of the hollow spaces 15, thereby achieving high radiation efficiency. The reduction in effective relative dielectric constant can lead to a reduction in the loss α caused by the dielectric material, and therefore, the band and gain of the planar antenna can also be increased.

The effective relative dielectric constant between the radiation conductors 31 and the ground conductor 32 can also be adjusted by changing a height of the hollow spaces 15. As shown in FIG. 1(c), H=hc+hs, where H represents a space between the radiation conductor 31 and the ground conductor 32, hs represents a height in the stacking direction of the hollow spaces 15, and hc represents the sum of heights of the ceramic layers. By decreasing hc/H or by increasing hs/H, the effective relative dielectric constant can be reduced, and therefore, the radiation efficiency of the planar antenna can be improved. In other words, the effective relative dielectric constant, which affects the radiation efficiency, can be adjusted without changing the ceramic material included in the multilayer ceramic body 10.

The space H between the radiation conductors 31 and the ground conductor 32 is, for example, not less than 50 μm and not more than 1 mm. As a result, a quasi-millimeter wave/millimeter wave band microstrip antenna can be configured. As the height hs of the hollow spaces 15 increases, the effective relative dielectric constant can preferably be reduced. However, if the height hs of the hollow spaces 15 is excessively great, for example, the ceramic layer that supports the radiation conductors 31 becomes thinner, and therefore, a sufficient structural strength may not be obtained. Therefore, the height hs of the hollow spaces 15 is preferably, for example, not less than 25 μm and not more than 900 μm.

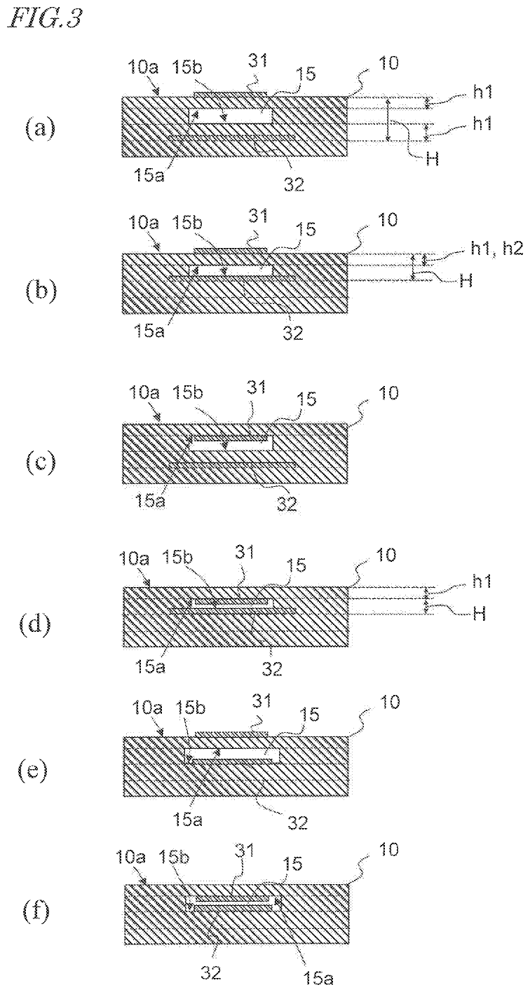

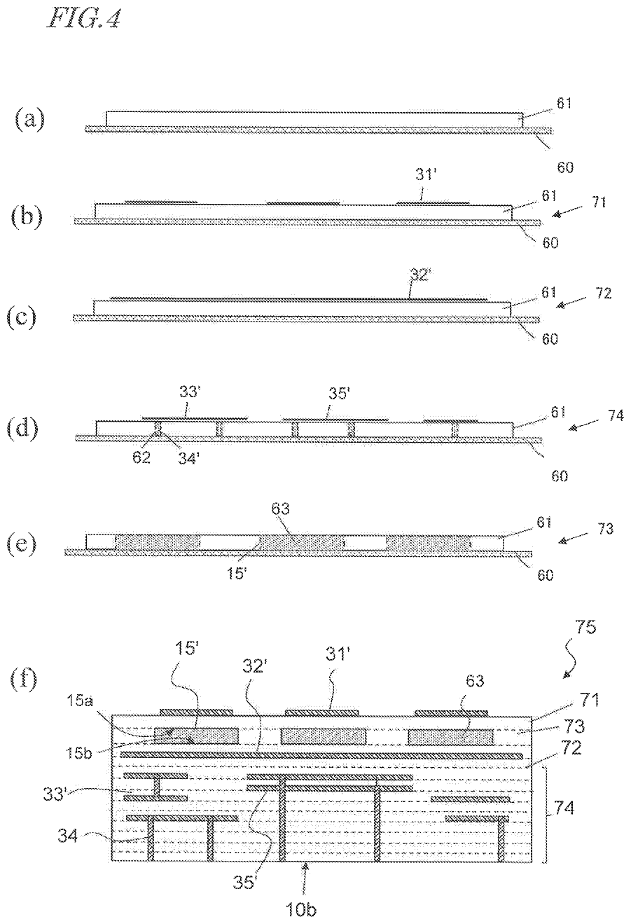

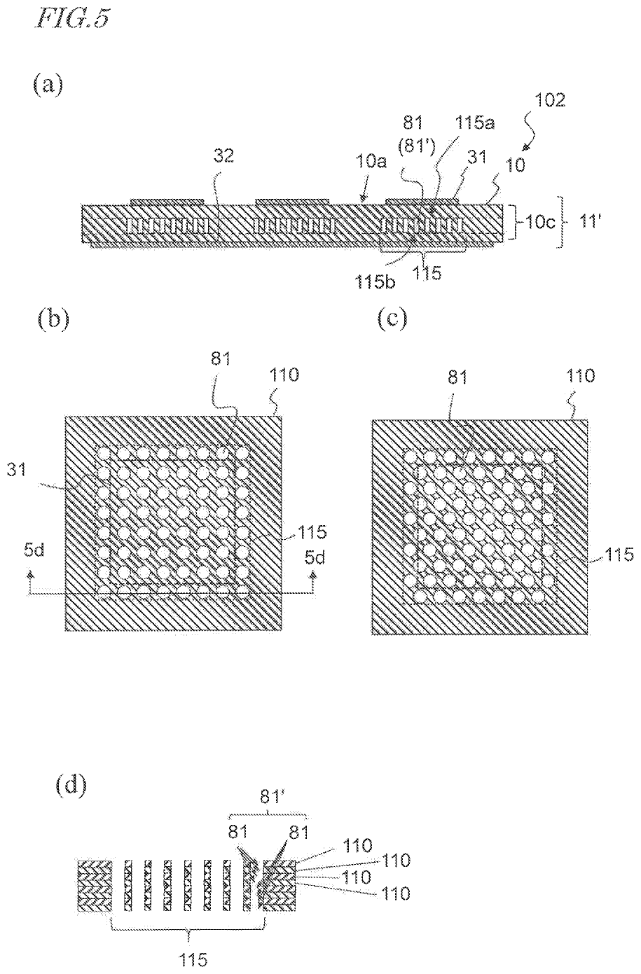

In the planar antenna 11 of the co-fired ceramic substrate, the arrangement of the radiation conductors 31, the ground conductor 32, and the hollow spaces 15 in the multilayer ceramic body 10 may be adapted in various ways. FIGS. 3(a) to 3(d) show examples. In these figures, the ground conductor 32 shown has a size corresponding to one radiation conductor 31. Alternatively, the ground conductor 32 may have a size corresponding to the array of six radiation conductors 31 as shown in FIGS. 1 and 2.

As shown in FIGS. 3(a) and 3(b), the radiation conductors 31 can be positioned on the upper surface 10a of the multilayer ceramic body 10. With this configuration, the radiation conductors 31 are in contact with an external environment in which radio waves are directly radiated, and therefore, high radiation efficiency is achieved. As shown in FIG. 3(a), in this case, a lower surface 15b of the hollow space 15 is separated from the ground conductor 32, and a ceramic layer may be present between the lower surface 15b of the hollow space 15 and the ground conductor 32. Alternatively, as shown in FIG. 3(b), the ground conductor 32 may be in contact with the hollow space 15, and the ground conductor 32 may define the lower surface 15b.

Alternatively, as shown in FIGS. 3(c) and 3(d), the radiation conductor 31 may be in contact with the hollow space 15. Specifically, in forms shown in FIGS. 3(c) and 3(d), an upper surface 15a of the hollow space 15 is defined by one of the interfaces between the plurality of ceramic layers at which the radiation conductor is positioned, and the radiation conductor 31 is positioned at the upper surface 15a. In this structure, the radiation conductor 31 is covered by the ceramic layer, and is not exposed to the external environment, and therefore, a reduction in the radiation efficiency and a change in characteristics of the antenna can be inhibited which would otherwise be caused by corrosion or oxidation of the radiation conductor 31 due to exposure thereof to the external environment. In addition, deformation, etc., of the radiation conductor 31 can be inhibited which would otherwise be caused by some external force applied to the radiation conductor 31 when a quasi-microwave/centimeter wave/quasi-millimeter wave/millimeter wave radio communication module is produced using the co-fired ceramic substrate 101. In particular, a quasi-millimeter wave/millimeter wave band antenna has a small size, and therefore, a small change in shape may cause a significant change in characteristics, and therefore, it is important to protect the radiation conductor 31.

In the case where the radiation conductor 31 is in contact with the hollow space 15, as shown in FIG. 3(c) the lower surface 15b of the hollow space 15 may be separated from the ground conductor 32, and a ceramic layer may be present between the lower surface 15b of the hollow space 15 and the ground conductor 32. Alternatively, as shown in FIG. 3(d), the ground conductor 32 may be in contact with the hollow space 15, and the ground conductor 32 may define the lower surface 15b.

In addition, in the case where the hollow space 15 has a size greater than that of the ground conductor 32 in a top view, as shown in FIGS. 3(e) and 3(f) the lower surface 15b of the hollow space 15 may be defined by one of the interfaces between the plurality of ceramic layers that is positioned at the ground conductor 32, and the ground conductor 32 may be positioned at the lower surface 15b. In particular, in the structure of FIG. 3(f), only the hollow space 15 is interposed between the radiation conductor 31 and the ground conductor 32, and therefore, the effective relative dielectric constant is about 1, and therefore, the loss α can be significantly reduced.

The co-fired ceramic substrate 101 may include an interconnection circuit. Specifically, as shown in FIG. 1(c), the co-fired ceramic substrate 101 may further include a passive component pattern 33 and an interconnection pattern 35 that are provided at a boundary between the plurality of ceramic layers that is positioned closer to the lower surface 10b than is the ground conductor 32, and conductive vias 34 that are provided in the plurality of ceramic layers that are positioned closer to the lower surface 10b than is the ground conductor 32. The passive component pattern 33 is, for example, a conductive layer, or a ceramic having a predetermined resistance value, and forms an inductor, a capacitor, a resistor, etc. The conductive vias 34 and the interconnection pattern 35 are coupled to the passive component pattern 33, the ground conductor 32, etc., to form a predetermined circuit.

Positioned on the lower surface 10b of the multilayer ceramic body 10 are, for example, an electrode 21 for connecting to an external substrate, an electrode 22 for connecting to a passive component, and an electrode 23 for connecting to a passive component such as an integrated circuit. The conductive vias 34 electrically connect the electrodes 21, 22, and 23 to the interconnection pattern 35, etc.

These elements provided in the plurality of ceramic layers that are positioned closer to the lower surface 10b than is the ground conductor 32, constitute an interconnection circuit 12 including passive components. By connecting a passive component, an integrated circuit, etc., to the above electrodes 22 and 23 of the interconnection circuit 12, a radio communication circuit is configured.

The interconnection circuit 12 and the radiation conductors 31 of the planar antenna 11 may be electrically connected directly together by at least the conductive vias 34 or the interconnection pattern 35 formed in the multilayer ceramic body 10. Alternatively, at least the conductive vias 34 or the interconnection pattern 35 may be disposed at a position where electromagnetic coupling with the radiation conductors 31 may be established. In that case, for example, a slot may be provided in the ground conductor 32, and the radiation conductors 31 and the interconnection pattern 35 may be disposed through the slot, or the interconnection pattern 35 may be provided between the radiation conductors 31 and the ground conductor 32.

The co-fired ceramic substrate 101 may be either a low temperature fired ceramic (LTCC, Low Temperature Co-fired Ceramics) substrate or a high temperature fired ceramic (HTCC, High Temperature Co-fired Ceramics) substrate. In terms of high-frequency characteristics, it may be more preferable that a low temperature fired ceramic substrate be used. In the ceramic layers of the multilayer ceramic body 10, the radiation conductors 31, the ground conductor 32, the passive component pattern 33, the interconnection pattern 35, and the conductive vias 34, a ceramic material and a conductive material are used which are suitable for the firing temperature, application, etc., and radio communication frequency, etc. Conductive pastes for forming the radiation conductors 31, the ground conductor 32, the passive component pattern 33, the interconnection pattern 35, and the conductive vias 34, and green sheets for forming the ceramic layers of the multilayer ceramic body 10, are co-fired. In the case where the co-fired ceramic substrate 101 is a low temperature fired ceramic substrate, a ceramic material and a conductive material that can be fired in a temperature range of about 800° C. to about 1000° C. are used. For example, a ceramic material containing Al, Si, and Sr as main components and Ti, Bi, Cu, Mn, Na, and K as sub-components, a ceramic material containing Al, Si, and Sr as main components and Ca, Pb, Na, and K as sub-components, a ceramic material containing Al, Mg, Si, and Gd, or a ceramic material containing Al, Si, Zr, and Mg, is used. Alternatively, a conductive material Ag or Cu is used. The ceramic material has a dielectric constant of about 3-15. In the case where the co-fired ceramic substrate 101 is a high temperature fired multilayer ceramic substrate, a ceramic material containing Al as a main component and a conductive material containing W (tungsten) or Mo (molybdenum) can be used.

More specifically, as a LTCC material, various materials such as, for example, Al—Mg—Si—Gd—O-based dielectric materials, dielectric materials containing a crystal phase of Mg₂SiO₄ and Si—Ba—La—B—O-based glass, etc., Al—Si—Sr—O-based dielectric materials, and Al—Si—Ba—O-based dielectric materials, which have a relative dielectric constant of 5-10, or Bi—Ca—Nb—O-based dielectric materials, which have a high dielectric constant (relative dielectric constant: 50 or more), can be used.

For example, in the case where an Al—Si—Sr—O-based dielectric material contains oxide of Al, Si, Sr, and Ti as main components, the Al—Si—Sr—O-based dielectric material preferably contains 10-60 mass % of Al₂O₃, 25-60 masst of SiO₂, 7.5-50 mass % of SrO, 20 mass % or less (including 0) of TiOz, assuming that Al, Si, Sr, and Ti, which are a main component, are converted into Al₂O₃, SiO₂, SrO, and TiO₂, respectively. The Al—Si—Sr—O-based dielectric material also preferably contains, as a sub-component, at least one of the group of Bi, Na, K, and Co, in an amount of 0.1-10 parts by mass in terms of Bi₂O₃, 0.1-5 parts by mass in terms of Na₂O, 0.1-5 parts by mass in terms of K₂O, and 0.1-5 parts by mass in terms of CoO, and further, at least one of the group of Cu, Mn, and Ag in an amount of 0.01-5 parts by mass in terms of CuO, 0.01-5 parts by mass in terms of Mn₃O₄, and 0.01-5 parts by mass of Ag, with respect to 100 parts by mass of the main component. The Al—Si—Sr—O-based dielectric material may also contain other incidental impurities.

The first portion 10c of the multilayer ceramic body 10 may have the same composition as that of the second portion 10d, and may be formed of the same material as that of the second portion 10d. Alternatively, in order to improve the radiation efficiency of the planar antenna 11, the first portion 10c of the multilayer ceramic body 10 may have a composition different from that of the second portion 10d, and may be formed of a material different from that of the second portion 10d. The first portion 10c having a composition different from that of the second portion 10d can have a dielectric constant different from that of the second portion 10d, and can have improved radiation efficiency.

[2. Production Method for Co-Fired Ceramic Substrate 101]

Next, a production method for the co-fired ceramic substrate 101 will be described. The co-fired ceramic substrate 101 can be produced using a production method similar to that for the LTCC substrate or the HTCC substrate.

(1) Step (A) of Preparing Ceramic Green Sheet

For example, initially, a ceramic material containing the above chemical elements is prepared, optionally pre-baked at, for example, 700° C. to 850° C., and pulverized for granulation. To the ceramic material, powder of a glass component, an organic binder, a plasticizer, and a solvent are added to obtain a slurry of a mixture thereof. In the case where the first portion 10c and the second portion 10d of the multilayer ceramic body 10 are formed of different materials so as to, for example, have different dielectric constants, two types of slurries containing different materials are prepared. In addition, powder of the above conductive material is mixed with an organic binder and a solvent, etc., to obtain a conductive paste.

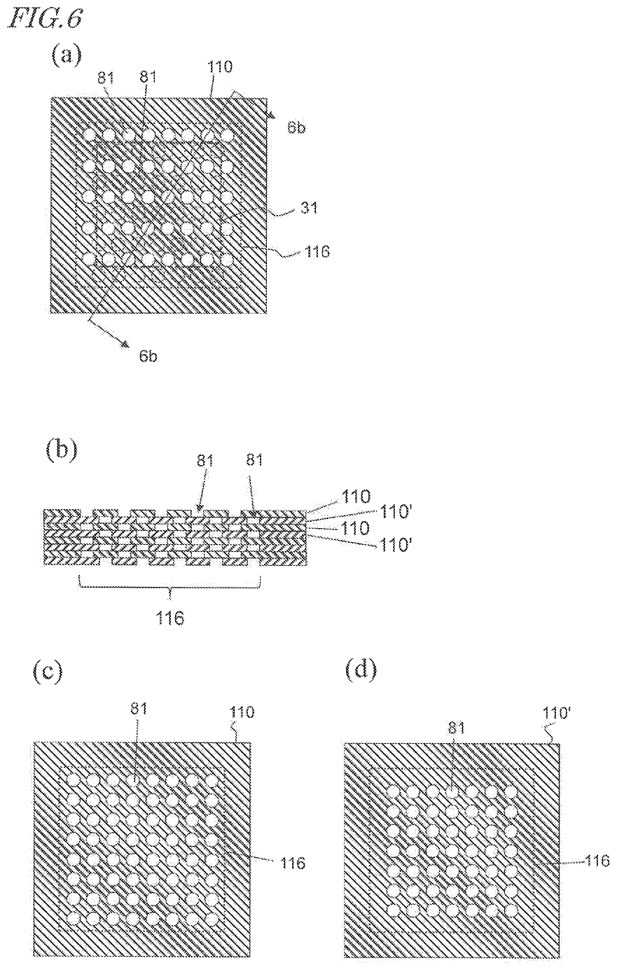

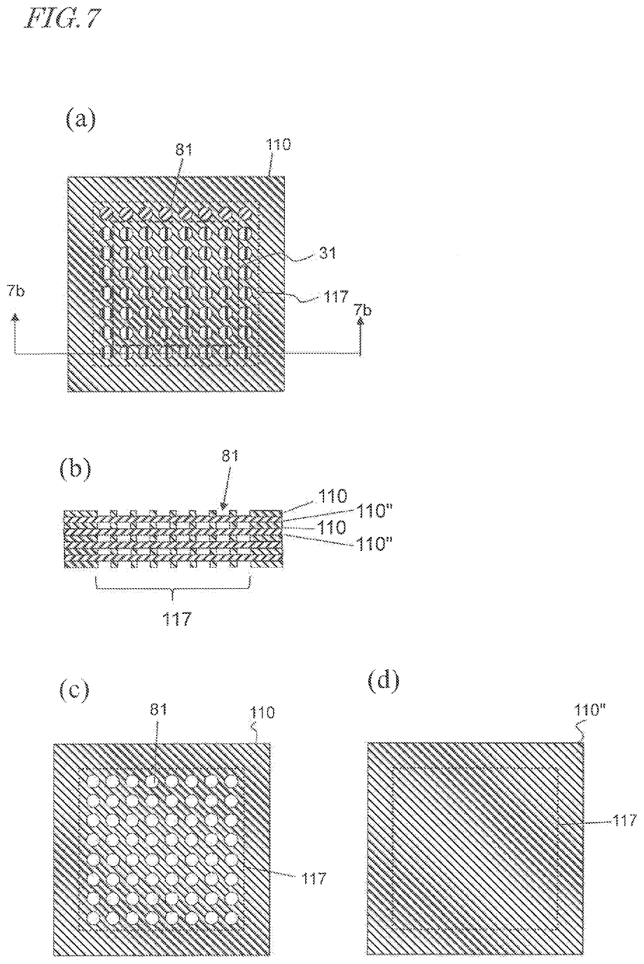

Using doctor blading, rolling (extrusion), printing, inkjet coating, transferring, or the like, as shown in FIG. 4(a), a layer having a predetermined thickness is formed from the slurry on a carrier film 60, and is dried. The slurry layer is cut to obtain ceramic green sheets 61.

The conductive paste is printed onto ceramic green sheets 61 to obtain, as shown in FIGS. 4(b) and 4(c), a ceramic green sheet (first ceramic green sheet) 71 on which conductive paste patterns 31′ for radiation conductors are disposed, and a ceramic green sheet (second ceramic green sheet) 72 on which a conductive paste pattern 32′ for a ground conductor is disposed. In addition, as shown in FIG. 4(d), according to a circuit that is to be configured in the co-fired ceramic substrate 101, via holes 62 are formed in a plurality of ceramic green sheets 61 using a laser, a mechanical puncher, or the like, and each via hole is filled with a conductive paste 34′ using screen printing. The conductive paste is printed onto the ceramic green sheets by screen printing or the like to obtain ceramic green sheets 74 on which a conductive paste pattern 35′ for an interconnection pattern and a conductive paste pattern 33′ for a passive component pattern are disposed.

As shown in FIG. 4(e), through openings 15′ corresponding to the hollow spaces 15 are formed in a ceramic green sheet 61 using a laser, a mechanical puncher, or the like. The through openings 15′ are larger than the conductive paste patterns 31′ for the radiation conductors.

A paste containing particles of an organic resin is prepared for filling the through openings 15′. A paste is formulated by mixing particles of an organic resin, a binder, and a solvent together. As the particles of an organic resin, for example, solid, hollow, or porous particles of an acrylic resin such as polymethyl methacrylate, an organic resin that have an average particle size of not less than 1 μm and not more than 30 μm. Here, the average particle size refers to a D50 value that is calculated from a particle size distribution measured by a laser diffraction/scattering method. Such particles of an organic resin are commercially available for applications such as a pore-forming material for ceramic filters, etc., and an organic light-weight filler requiring strength. Thermally expandable microcapsules may be used. A thermally expandable microcapsule has a structure in which a low-boiling-point hydrocarbon is covered by a thermoplastic polymer shell, and when the thermally expandable microcapsule is heated, the polymer shell softens and the low-boiling-point hydrocarbon vaporizes, so that the thermally expandable microcapsule expands. In the case where thermally expandable microcapsules are used, the thermally expandable microcapsules are preferably expanded in advance by a thermal treatment. This is because deformation of the through openings 15′ is inhibited that would otherwise occur due to expansion of the thermally expandable microcapsules in a debinding step or the like after a green sheet laminate is formed. As the binder and the solvent, a binder and solvent that are commonly used in production of a co-fired ceramic substrate can be used.

The through openings 15′ of the ceramic green sheet 61 are filled with the prepared paste containing the particles of an organic resin by printing or the like, to obtain a ceramic green sheet (third ceramic green sheet) 73 in which the through openings 15′ are filled with the paste 63 containing the particles of an organic resin.

(2) Step (B) of Obtaining Green Sheet Laminate

The prepared ceramic green sheets 71, 72, 73, 74 are stacked together. As shown in FIG. 4(f), initially, the plurality of ceramic green sheets 74 are stacked together while being temporarily joined together by pressing so as to configure a predetermined interconnection circuit. Thereafter, stacking is performed such that the ceramic green sheet 73 is positioned between the ceramic green sheet 71 and the ceramic green sheet 72. Specifically, the ceramic green sheet 72 is disposed on the plurality of ceramic green sheets 74, and the ceramic green sheet 73 is disposed on the ceramic green sheet 72. A plurality of the ceramic green sheets 73 may be disposed, depending on the height of the hollow spaces 15 that are to be formed. Thereafter, the ceramic green sheet 71 is disposed on the ceramic green sheet 73. Positioning is performed such that the conductive paste patterns 31′ for the radiation conductors of the ceramic green sheet 71 are positioned in regions above or below the through openings 15′ of the ceramic green sheet 73, and the ceramic green sheet 73 is positioned between the ceramic green sheet 71 and the ceramic green sheet 72. Thus, a green sheet laminate 75 is obtained.

Note that in FIG. 4, regions in which the hollow spaces 15 are to be formed are formed in the single ceramic green sheet 73, which is not necessarily limiting. For example, a plurality of the ceramic green sheets 73 can also be prepared and stacked, so that multiple through openings 15′ and pastes 63 are stacked together, to form single hollow spaces 15 having an increased height.

Next, the plurality of ceramic green sheets 71-74 of the green sheet laminate 75 are joined together by pressing. For example, the green sheet laminate 75 is mounted in a frame, and is fully joined together by pressing using a cold isostatic pressing (CIP) device or the like.

(3) Step (C) of Firing Green Sheet Laminate

Initially, debinding is performed. Specifically, organic components such as a resin and a solvent that are contained in the green sheet laminate 75 are removed by heating. In this step, the paste 63 filling the through openings 15′ that are to form the hollow spaces 15 is also removed. For example, maintenance is performed at a temperature in the range of not lower than 200° C. and not higher than 600° C. for a period of time of not shorter than 120 min and not longer than 600 min. The maintenance temperature may be constant or variable. This step causes the resin and solvent contained in the green sheet laminate 75 to disappear (evaporate). The particles of an organic resin in the paste 63 disappear at a temperature in the range of, for example, about 350° C. to about 600° C. In the typical debinding step in the multilayer ceramic substrate production process, the conductive paste in the conductive patterns interposed between the ceramic green sheets and the conductive paste filling the via holes of the ceramic green sheets can be removed, and likewise, the paste 63 surrounded by the ceramic green sheets is removed in the form of gas. The through openings 15′ from which the paste 63 was removed are filled with the atmosphere or a gas included in an ambient gas during the debinding or firing.

Next, the green sheet laminate 75 after the debinding is fired. Specifically, the green sheet laminate 75 is maintained at a firing temperature for a ceramic contained in the ceramic green sheets, so that the ceramic is fired. For example, the maintenance is, for example, performed at a temperature in the range of not lower than 850° C. and not higher than 940° C. for a period of time of not shorter than 100 min and not longer than 180 min.

As shown in FIG. 1(c), after the firing, the electrodes 21, 22, 23 are disposed on the lower surface 10b to obtain the co-fired ceramic substrate 101.

The co-fired ceramic substrate of this embodiment is provided with an interconnection circuit, passive component, and planar antenna for quasi-microwave/centimeter wave/quasi-millimeter wave/millimeter wave radio communication. Therefore, by mounting a chip set for quasi-microwave/centimeter wave/quasi-millimeter wave/millimeter wave radio communication on the co-fired ceramic substrate, a radio communication module with an antenna is implemented. For example, in the case of carrier waves of 24 GHz or more, a rectangular radiation conductor has a size of 6 mm×6 mm or less, and can be preferably disposed in a radio communication module including the co-fired ceramic substrate.

In addition, the hollow spaces are provided between the radiation conductors 31 and the ground conductor 32, and therefore, the effective relative dielectric constant in the planar antenna can be reduced, so that the loss caused by the dielectric material can be inhibited, and therefore, the radiation efficiency of the planar antenna can be improved. In addition, by changing the height of the hollow spaces 15, the effective relative dielectric constant in the planar antenna can be changed. Therefore, even when the same ceramic material is used, planar antennas having different characteristics can be implemented by changing the relative dielectric constant.

In addition, according to the production method for the co-fired ceramic substrate of this embodiment, the through openings that are to form the hollow spaces are filled with a paste containing particles of an organic resin to produce the green sheet laminate 75. Therefore, the co-fired ceramic substrate having the hollow spaces can be obtained without deformation of the through openings or reduction of the spaces due to pressure joining or the like.

Note that the shapes, numbers, arrangements of the radiation conductors 31 and the ground conductor 32 of the planar antenna described in this embodiment are merely schematic examples. For example, a portion of the plurality of radiation conductors may be disposed at an interface between ceramic layers that is positioned at a different distance from the ground conductor 32. In addition, a slot may be provided in the radiation conductors. In addition, the planar antenna may further include a conductor to which power is not supplied, in addition to the radiation conductors, and such a conductor and the radiation conductors may be stacked together with a ceramic layer interposed therebetween.

### Second Embodiment

A second embodiment of a planar antenna and a co-fired ceramic substrate will be described. FIG. 5(a) is a schematic cross-sectional view of a planar antenna 11′ of a co-fired ceramic substrate 102 according to the second embodiment of the present disclosure. The planar antenna 11′ is different from the planar antenna 11 of the co-fired ceramic substrate 101 of the first embodiment in that low-dielectric-constant regions 115 are provided, instead of the hollow spaces, in the multilayer ceramic body 10 between the radiation conductors 31 and the ground conductor 32. For example, an interconnection circuit 12 of the co-fired ceramic substrate 102 has the same structure as that of the interconnection circuit 12 of the co-fired ceramic substrate 101 of the first embodiment. In FIG. 5(a), the interconnection circuit 12 is not shown. For example, the positions, structure, etc., of the radiation conductors 31 and the ground conductor 32 of the planar antenna 11′ are the same as those of the planar antenna 11 described in the first embodiment. Therefore, in this embodiment, the structure of the low-dielectric-constant regions 115 will be mainly described.

The low-dielectric-constant regions 115 are positioned between the radiation conductors 31 and the ground conductor 32 in the multilayer ceramic body 10. In the multilayer ceramic body 10, the low-dielectric-constant region 115 includes a plurality of hollow portions, and has a relative dielectric constant lower than those of the other regions. The hollow portions are not filled with the ceramic material contained in the multilayer ceramic body 10 or any other solid or liquid material.

In the example of FIG. 5(a), the low-dielectric-constant region 115 includes through holes 81 as the hollow portions. FIG. 5(b) is a top view of the low-dielectric-constant region 115 positioned in the multilayer ceramic body 10, and FIG. 5(d) is a cross-sectional view of the low-dielectric-constant region 115 taken along line 5d-5d of FIG. 5(b). The multilayer ceramic body 10 includes a plurality of ceramic layers 110 corresponding to ceramic green sheets that were stacked during production, and the through holes 81 are provided in at least one of the ceramic layers 110. As described above, the through holes 81 are not filled with the ceramic material contained in the multilayer ceramic body 10 or any other solid or liquid material. The through holes 81 are filled with the atmosphere or a gas filling an ambient gas during firing.

In this embodiment, in a plane perpendicular to the stacking direction of the ceramic layers 110, the plurality of through holes 81 are two-dimensionally arranged in two directions, for example, two orthogonal directions. As shown in FIG. 5(c), the plurality of through holes 81 may be provided in a staggered arrangement in each ceramic layer 110. As shown in FIG. 5(d), for example, the plurality of ceramic layers 110 are adjacent to each other, and the plurality of through holes 81 of two or more adjacent ones of the ceramic layers 110 are aligned in the stacking direction of the ceramic layers 110. In other words, the through holes 81 of the ceramic layers 110 are connected together in the stacking direction of the ceramic layers 110 to form long through holes 81′. For example, the through holes 81′ have an opening at an upper surface 115a and a lower surface 115b of the low-dielectric-constant region 115.

The number and size (diameter) of the through holes 81 may be arbitrarily determined, based on the relative dielectric constant required for the low-dielectric-constant region 115. The relative dielectric constant εᵣ of the low-dielectric-constant region 115 can be determined by:

εᵣ=1×vₕ+ε_{rc}×(1−vₕ)

where εᵣ represents the relative dielectric constant of the low-dielectric-constant region 115, ε_{rc} represents the relative dielectric constant of the ceramic material of the multilayer ceramic body 10, the relative dielectric constant of air is 1, and vₕ represents the volume ratio of the through holes 81′ in the low-dielectric-constant region 115.

Note that an effective volume ratio (or also simply referred to as a “volume ratio”) is represented by:

the effective volume ratio=the volume (total) of the vias in the low-dielectric-constant region/the volume of the dielectric material in the low-dielectric-constant region.

The low-dielectric-constant region is a region that surrounds the through holes (vias) 81, in the case of FIG. 5, and is indicated by the reference numeral 115. The volume (total) of the vias is equivalent to the total of the volumes of the through holes. The addition of the volume (total) of the vias in the low-dielectric-constant region and the volume of the dielectric material in the low-dielectric-constant region is equivalent to the volume of the low-dielectric-constant region.

The low-dielectric-constant region 115 of the multilayer ceramic body 10 includes the plurality of through holes 81 that are not filled with a solid such as a ceramic material, and therefore, has a small relative dielectric constant compared to when the entire low-dielectric-constant region 115 is formed of a ceramic material. Therefore, as in the first embodiment, the effective relative dielectric constant of the planar antenna can be reduced, so that the loss caused by the dielectric material can be inhibited, and therefore, the radiation efficiency of the planar antenna can be improved. In addition, by changing the number and size of the through holes 81, the relative dielectric constant of the low-dielectric-constant region 115 can be adjusted. Thus, the design flexibility of the planar antenna can be improved.

Furthermore, in the low-dielectric-constant region 115, the ceramic material is present around the through holes 81 to serve as a structural member for supporting the perimeters of the through holes 81. This inhibits deformation of the multilayer ceramic body 10 caused by its non-uniform shrinkage during firing. In addition, the ceramic material present around the through holes 81 inhibits a reduction in structural strength.

The co-fired ceramic substrate 102 can be produced using a method similar to that for the co-fired ceramic substrate 101 of the first embodiment. Specifically, in the production method of the first embodiment (see FIG. 4(d)), a ceramic green sheet having holes corresponding to the plurality of through holes 81 may be used instead of the ceramic green sheet 73 in which the through openings 15′ are filled with the paste 63. In this case, the holes may or may not be filled with the paste 63 containing particles of an organic resin. The holes corresponding to the plurality of through holes 81 may be formed by punching working or laser working.

In the case where the paste 63 is used, the co-fired ceramic substrate 102 can be produced using, for example, the following method. Although, in the description that follows, only the low-dielectric-constant region 115 will be described, the entire co-fired ceramic substrate 102 can be produced using a method similar to that for the co-fired ceramic substrate 101 of the first embodiment.

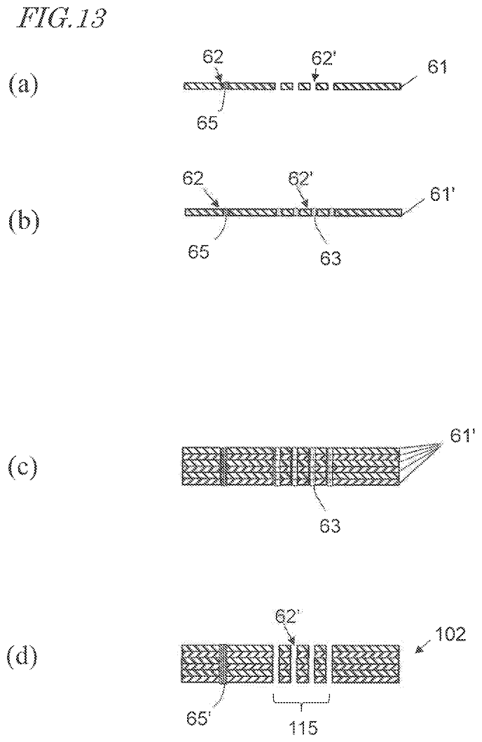

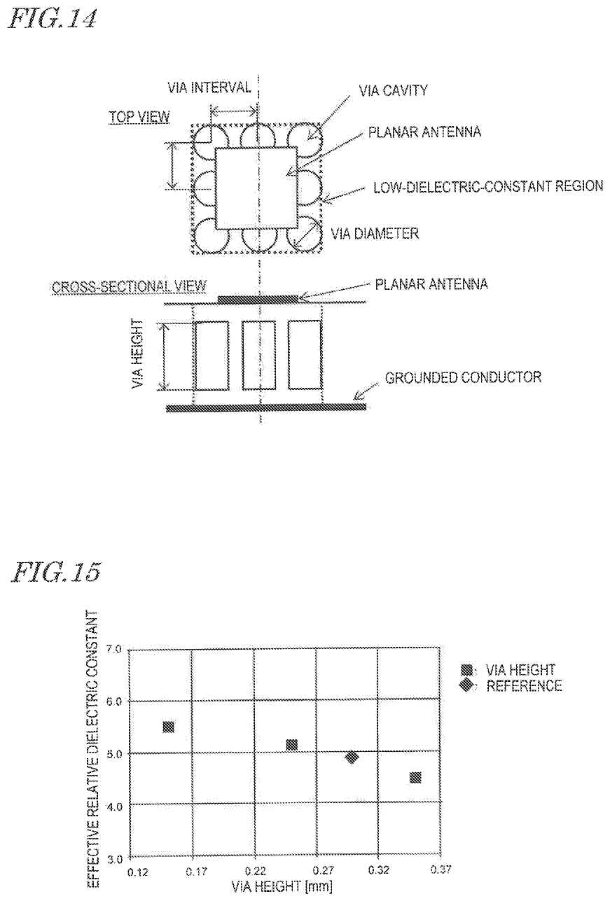

Initially, as shown in FIG. 13(a), a ceramic green sheet 61 is prepared. In the case where conductive vias and conductive patterns are formed in the same layer in which the low-dielectric-constant region 115 is provided, for example, through holes 62 are formed in the ceramic green sheet 61, and are filled with a conductive paste 65 for conductive vias and conductive patterns. Thereafter, a plurality of through holes 62′ are formed in a region of the ceramic green sheet 61 that is to be the low-dielectric-constant region 115. Thereafter, as shown in FIG. 13(b), the through holes 62′ of the ceramic green sheet 61 are filled with a paste 63 containing an organic resin. For example, the plurality of through holes 62′ are filled with the paste 63 using a printing method.

Next, as shown in FIG. 13(c), the ceramic green sheets 61′ filled with the paste 63 are stacked together, and joined together by pressing. Thereafter, the laminate of the ceramic green sheets 61′ is heated at a high temperature so that the ceramic green sheets 61′ are sintered. At this time, an organic resin and a solvent, etc., contained in the paste 63 disappear due to heat. Thus, as shown in FIG. 13(d), the co-fired ceramic substrate 102 having conductive vias 65′ and the low-dielectric-constant region 115 is obtained. The through holes 62′ after the firing are equivalent to the through holes 81. With this production method, the through holes 62′ are filled with the paste 63, and therefore, when the ceramic green sheets are stacked together and joined together by pressing, the shapes of the through holes 62′ are less likely to be deformed, and therefore, misalignment of the ceramic green sheets during stacking is inhibited, so that variations in shape and performance during production are inhibited. As a result, the co-fired ceramic substrate 102 meeting its specification can be obtained.

Note that in the case where the through holes 62′ are filled with the paste 63, the through holes 81 after the firing preferably have a diameter of, for example, about 0.12 mm to about 0.15 mm. If the diameter of the through holes 81 is less than 0.12 mm, it is difficult to place the paste 63 only in the through holes 62′, and the paste 63 is more likely to spread. If the diameter of the through holes 81 is more than 0.15 mm, for example, it is difficult to efficiently form the through holes 63 using laser. In addition, the through holes 62′ that are to be a cavity have a larger region, and therefore, the mechanical strength of the co-fired ceramic substrate 102 in the low-dielectric-constant region 115 is likely to decrease.

The plurality of through holes 81 may be arranged in other patterns in the low-dielectric-constant region 115. FIG. 6(a) is a top view of a low-dielectric-constant region 116 of the multilayer ceramic body 10, and FIG. 6(b) is a cross-sectional view of the low-dielectric-constant region 116 taken along line 6b-6b of FIG. 6(a). In the form shown in FIG. 6, in the low-dielectric-constant region 116, the positions of the through holes 81 are different between two adjacent ceramic layers in the plurality of ceramic layers. For example, in the odd-numbered ceramic layers 110 of the plurality of ceramic layers, the plurality of through holes 81 are arranged at positions indicated by a solid line, and in the even-numbered ceramic layers 110′, the plurality of through holes 81 are arranged at positions indicated by a dotted line. More specifically, the plurality of through holes 81 in the even-numbered ceramic layers 110′ are each disposed at a center of four of the through holes 81 in the odd-numbered ceramic layers 110 so as not to overlap the through holes 81 in the odd-numbered ceramic layers 110. For example, ceramic layers 110 and 110′ shown in FIGS. 6(c) and 6(d) are alternately stacked.

In the low-dielectric-constant region 116, the plurality of through holes 81 are arranged in a more distributed fashion. Therefore, the uniformity of the relative dielectric constant in the low-dielectric-constant region 116 is increased. The through holes 81, serving as hollow portions, are also distributed, so that structural strength in the low-dielectric-constant region 116 is more uniform, and therefore, the reduction in deformation and structural strength due to firing is further inhibited.

FIG. 7(a) is a top view of a low-dielectric-constant region 117 of the multilayer ceramic body 10, and FIG. 7(b) is a cross-sectional view of the low-dielectric-constant region 117 taken along line 7b-7b of FIG. 7(a). In the form of FIG. 7, in the low-dielectric-constant region 117, a ceramic layer in which a through hole is not formed is positioned between a plurality of ceramic layers. In the form of FIG. 7, for example, in odd-numbered ceramic layers 110 of the plurality of ceramic layers, a plurality of through holes 81 are disposed, and in even-numbered ceramic layers 110′, a through hole 81 is not disposed. More specifically, ceramic layers 110 and ceramic layers 110″ of FIGS. 7(c) and 7(d) are alternately stacked. In the above embodiment, in the low-dielectric-constant region of the multilayer ceramic body, through holes penetrating through the ceramic layers are provided as the hollow portions. Alternatively, the hollow portions may have a plurality of hollow portions that do not penetrate through the ceramic layers.

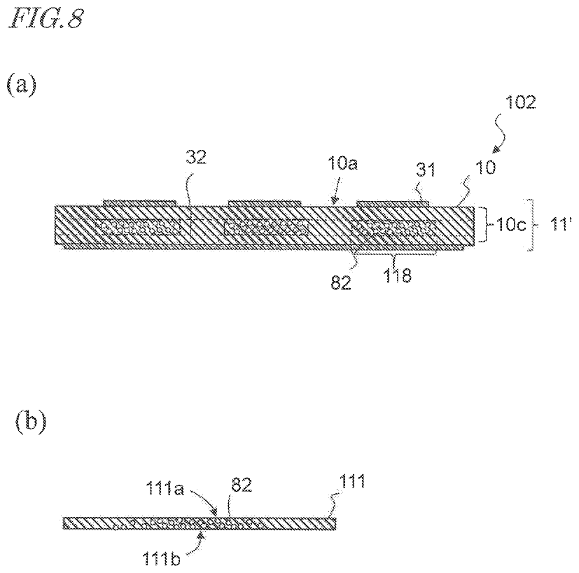

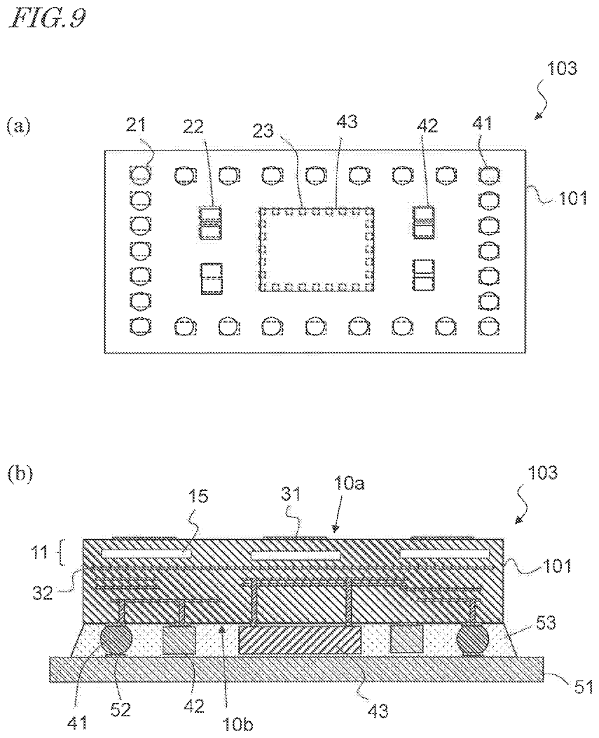

FIG. 8(a) shows a cross-section of a planar antenna 11′ of a co-fired ceramic substrate 102 including a low-dielectric-constant region 118 having a plurality of hollow portions 82 that do not penetrate through a ceramic layer. FIG. 8(b) shows a cross-section of one ceramic layer 111 included in the low-dielectric-constant region 118 of the multilayer ceramic body 10.

As described above, in the low-dielectric-constant region 118, the hollow portions 82 are provided in one or more ceramic layers 111 of the plurality of ceramic layers. The hollow portions 82 are a space that does not penetrate through a ceramic layer 111. For example, the hollow portion 82 is not a through hole that has an opening simultaneously at an upper surface 111a and a lower surface 111b of a ceramic layer 111, and is a space enclosed in a ceramic layer 111 or a recessed portion that has an opening at one of the upper surface 111a and the lower surface 111b of a ceramic layer 111. Such a hollow portion 82 can, for example, be formed by distributing, in a ceramic green sheet, microcapsules or the like that have a diameter smaller than the thickness of the ceramic green sheet and is formed of an organic material, and causing the microcapsules or the like to disappear during a debinding step or a firing step.

The relative dielectric constant of such a low-dielectric-constant region 118 can be relatively easily adjusted by changing the proportion of the hollow portions 82 in the low-dielectric-constant region 118. For example, the relative dielectric constant of the low-dielectric-constant region 118 can be adjusted only by changing the amount of microcapsules added to a ceramic slurry for forming a ceramic green sheet.

In this embodiment, the cross-section shown of the through hole is not limited to a circle and may be an ellipse, a polygon, or the like. In addition, the number of ceramic layers in which the low-dielectric-constant regions 115, 116, 117, and 118 are formed can be arbitrarily set. Furthermore, in the forms of FIGS. 6 and 7, the ceramic layers 110 and the ceramic layers 110′, and the ceramic layers 110 and the ceramic layers 110″, may not alternately be stacked, and may be stacked in groups of two or more, or may be stacked randomly.

In addition, the hollow portions may be arranged at regular intervals or at irregular intervals in a top view the low-dielectric-constant region. Furthermore, the hollow portions may not uniformly be distributed in the low-dielectric-constant region in a top view. For example, in a top view, the relative dielectric constant in the low-dielectric-constant region can be allowed to have a distribution by changing the proportion of the area of the hollow portions in the vicinity of the center of the low-dielectric-constant region to the area of the hollow portions in the vicinity of the periphery of the low-dielectric-constant region.

### Third Embodiment

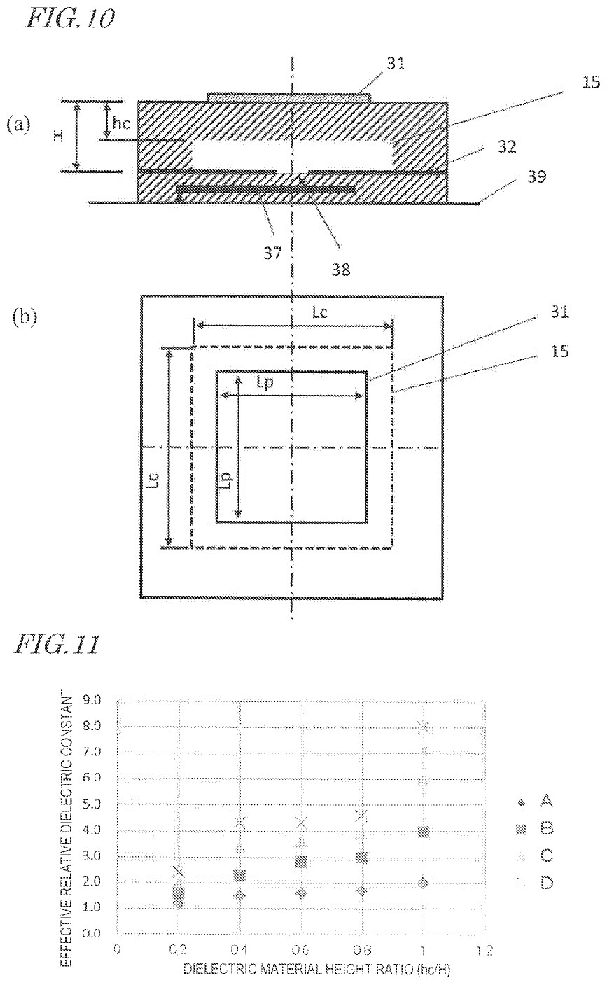

An embodiment of a quasi-microwave/centimeter wave/quasi-millimeter wave/millimeter wave radio communication module will be described. FIG. 9(a) is a schematic bottom view showing an embodiment of a radio communication module according to the present disclosure, and FIG. 9(b) is a schematic cross-sectional view showing the radio communication module mounted on a substrate. The radio communication module 103 includes the co-fired ceramic substrate 101 of the first embodiment, solder bumps 41, a passive component 42, and an active component 43. The solder bumps 41 are provided at the electrodes 21 positioned on the lower surface 10b of the co-fired ceramic substrate 101. The passive component 42 is, for example, a chip capacitor, a chip inductor, a chip resistor, or the like, and is joined to the electrode 22 by solder or the like. The active component 43 is, for example, a chip set for radio communication, includes a receiver circuit, a transmitter circuit, an A/D converter, a D/A converter, a base-band processor, a media access controller, and the like, and is joined to the electrode 23 by solder or the like.

The radio communication module 103 is, for example, joined to a circuit substrate 51 on which an electrode 52 is provided, by flip chip bonding, with the radio communication module 103 facing down, i.e. the passive component 42 and the active component 43 facing the circuit substrate 51. A space between the co-fired ceramic substrate 101 and the circuit substrate 51 is filled with, for example, a molding resin 53.

In the radio communication module 103 mounted on the circuit substrate 51, the upper surface 10a of the co-fired ceramic substrate 101 is positioned on the opposite side from the circuit substrate 51. Therefore, quasi-microwave/centimeter wave/quasi-millimeter wave/millimeter wave band radio waves can be radiated from the planar antenna 11, and quasi-microwave/centimeter wave/quasi-millimeter wave/millimeter wave band radio waves coming from the outside can be received by the planar antenna 11, without an influence of the passive component 42 and the active component 43, or the circuit substrate 51. In addition, the planar antenna 11 includes the hollow spaces 15, and therefore, although the planar antenna 11 is provided in the co-fired ceramic substrate, the planar antenna 11 has a small effective relative dielectric constant, and can achieve high radiation efficiency. Therefore, a small and surface-mountable radio communication module can be achieved which includes an antenna capable of transmitting and receiving radio waves with high radiation efficiency.

In this embodiment, the radio communication module 103 including the co-fired ceramic substrate 101 of the first embodiment has been described. Alternatively, the radio communication module may include the co-fired ceramic substrate 102 of the second embodiment.

### EXPERIMENTAL EXAMPLES

### Experimental Example 1

It was confirmed, by calculation, that the effective relative dielectric constant can be controlled by the hollow spaces. The effective relative dielectric constant was calculated using a planar antenna having a shape shown in FIG. 10. A model was used in which as shown in FIG. 10, a slot 38 is provided in the ground conductor 32 that is in contact with the hollow space, and power is supplied from a microstrip line including a power supply line 37 and a grounded conductor 39, through the slot 38, to the radiation conductor 31. H=0.4 mm, Lc/Lp=2, and the value of hc was varied. The relative dielectric constants of materials A-D for the multilayer ceramic were set to 2, 4, 6, 8. The results are shown in FIG. 11. In FIG. 11, the horizontal axis represents the value of hc/H, and the vertical axis represents the effective relative dielectric constant.

In the case where hc/H=1, there is no hollow space. For any of the materials A to D for the multilayer ceramic body 10, the effective relative dielectric constant significantly decreases in the case where hc/H is less than 1. In particular, as the relative dielectric constant of the material for the multilayer ceramic body 10 increases, the effective relative dielectric constant decreases. In the case where hc/H is in the range of 0.4-0.8, changes in the value of the effective relative dielectric constant are small.

Specifically, in the case where hc/H is in the range of 0.4-0.8, the effective relative dielectric constant is in the range of 1.5-1.7 for the material A (relative dielectric constant: 2), and the effective relative dielectric constant is in the range of 4.3-4.6 for the material D (relative dielectric constant: 8).

These results demonstrated that the presence of the hollow spaces has the effect of significantly reducing the relative dielectric constant of the material of the multilayer ceramic body 10, and that as hc/H decreases, the effective relative dielectric constant also decreases.

### Experimental Example 2

The effective relative dielectric constant was confirmed by calculation for different structures of the planar antenna. The two-dimensional shapes of the radiation conductors 31, the ground conductor 32, and the hollow spaces 15 are the same as those of Experimental Example 1, and radiation efficiency was determined by calculation for the structures of FIGS. 3(a), 3(b), 3(d). H, h1, h2 shown in the figures are as described below. Calculation was performed, assuming that the thicknesses of the radiation conductor 31 and the ground conductor 32 are zero. In addition, the relative dielectric constant of the material for the multilayer ceramic was set to 6.

### H: 0.4 mm

h1: 0.16 mm
h2: 0.08 mm

The results are shown in Table 1.

TABLE 1

| | | Effective relative |
|---|---|---|
| Sample no. | Structural model | dielectric constant |
| 1 | FIG. 3(b), (h1) | 3.4 |
| 2 | FIG. 3(b), (h2) | 2.0 |
| 3 | FIG. 3(d) | 2.2 |
| 4 | FIG. 3(a) | 4.9 |

As can be shown from Table 1, even when a multilayer ceramic having the same relative dielectric constant is used, the effective relative dielectric constant can be changed by changing the positions of the radiation conductor 31, the ground conductor 32, and the hollow space 15. Therefore, the radiation efficiency, band, and gain of an antenna can be increased, and characteristics of an antenna can be adjusted by changing the effective relative dielectric constant, depending on the purpose and specification.

### Experimental Example 3

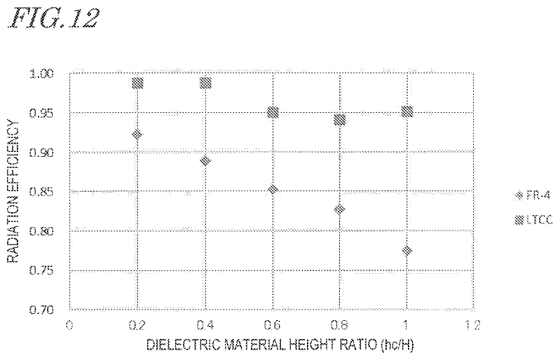

Radiation efficiency was determined by calculation, where as the dielectric material, the physical properties of a low-temperature co-fired ceramic (LTCC) and a glass epoxy (FR-4) were used, and the height of the hollow space was changed as in Experimental Example 1. In the calculation, the values of the relative dielectric constant and tan δ shown in Table 2 were used. The results are shown in FIG. 12.

TABLE 2

| | Relative dielectric | |
|---|---|---|
| Material | constant | Tanδ |
| Glass epoxy (FR-4) | 4 | 10⁻² |
| Ceramic (LTCC) | 6 | 10⁻⁴ |

As can be seen from FIG. 12, for any of a planar antenna employing the glass epoxy as the dielectric material and a planar antenna employing the low-temperature co-fired ceramic as the dielectric material, as hc/H decreases, the radiation efficiency increases. However, the change in the radiation efficiency varies depending on the dielectric material. Specifically, for the planar antenna employing the glass epoxy as the dielectric material, as the height of the hollow space decreases, and therefore, the height ratio hc/H of the dielectric material increases, the radiation efficiency significantly decreases. In contrast to this, for the planar antenna employing the low-temperature co-fired ceramic as the dielectric material, even when the height ratio of the dielectric material increases, the radiation efficiency does not decrease very much. This may be because while for any of the ceramic and the glass epoxy, the tan δ of the hollow space is zero, the tan δ of the glass epoxy is greater than that of the ceramic, and therefore, as the height ratio of the dielectric material increases, the loss α due to tan δ increases, so that the radiation efficiency decreases. Thus, it is understood that the planar antenna of the present disclosure has high radiation efficiency, particularly in the case where a ceramic is used as the dielectric material.

### Experimental Example 4

In the co-fired ceramic substrate of the second embodiment, a relationship between the shape and arrangement of the hollow portions and the effective relative dielectric constant of the low-dielectric-constant region was determined by calculation. Using a structure shown in FIG. 14, cylindrical via cavities were set as hollow portions, and a relationship between the height, interval, and diameter of the via cavities and the effective relative dielectric constant was determined. The calculation was performed, assuming that the relative dielectric constant of the dielectric material is 6. FIGS. 15, 16, and 17 show a relationship between the via height, via interval, and via diameter and the effective relative dielectric constant. As the via height and via diameter (via size) increase, the volume of the hollow portion increases, and therefore, the effective relative dielectric constant tends to decrease. Meanwhile, as the via interval increases, the volume of the dielectric material portion increases, and therefore, the effective relative dielectric constant tends to increase.

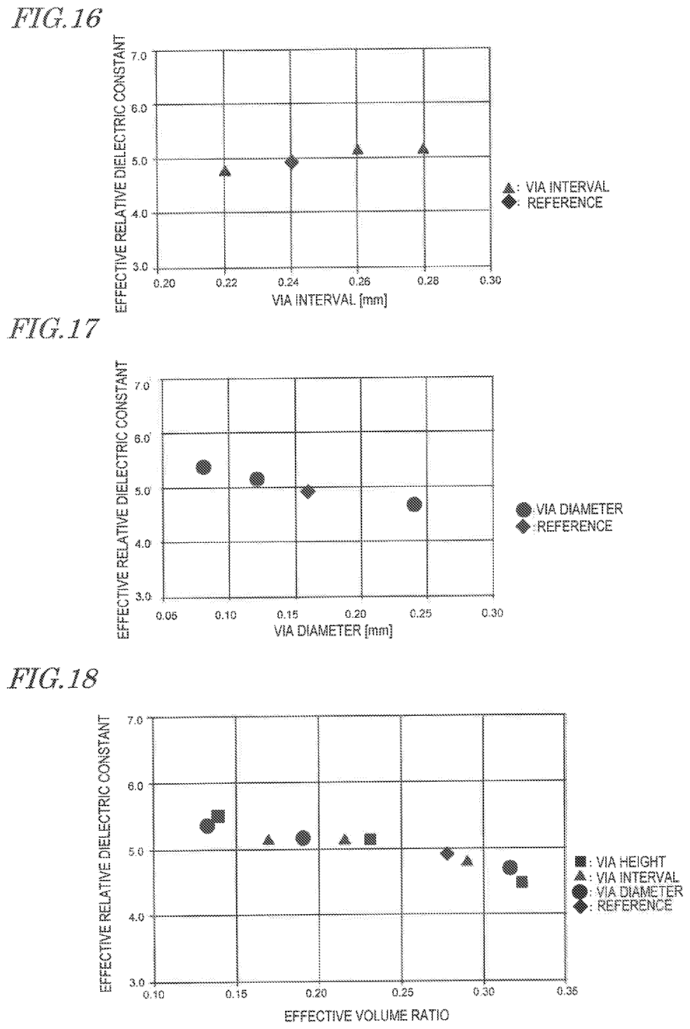

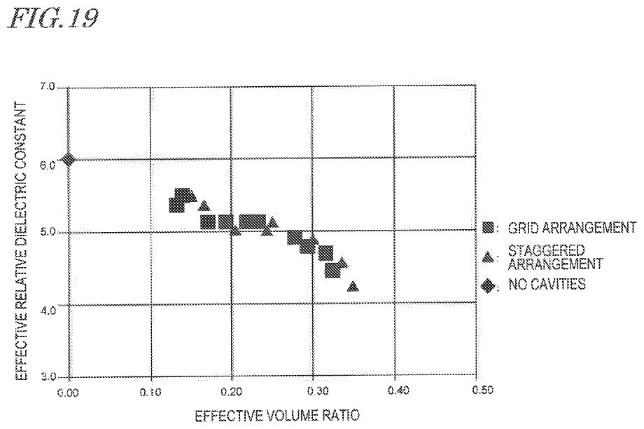

FIG. 18 shows a relationship between the effective volume ratio and the effective relative dielectric constant, indicating the result of determination of the effective relative dielectric constant by changing the via height, via interval, and via diameter. As shown in FIG. 18, as the effective volume ratio of the hollow portion increases, the effective relative dielectric constant decreases, irrespective of the shape of the hollow portions.

FIG. 19 shows a relationship between the effective volume ratio and the effective relative dielectric constant, indicating the result of determination of the effective relative dielectric constant by changing the size of the hollow portions in the case where the hollow portions were arranged in a grid pattern (FIG. 5) and in the case where the hollow portions were arranged in a staggered pattern (FIG. 6). As the effective volume ratio of the hollow portions increases, the effective relative dielectric constant decreases, irrespective of the difference between the arrangement patterns of the hollow portions.

These results demonstrated that the effective relative dielectric constant of the low-dielectric-constant region can be adjusted by arranging the hollow portions of various sizes in various arrangement patterns in the low-dielectric-constant region.

### INDUSTRIAL APPLICABILITY

The planar antenna, co-fired ceramic substrate, and quasi-microwave/centimeter wave/quasi-millimeter wave/millimeter wave radio communication module of the present disclosure can be preferably used in various high-frequency radio communication antennas and radio communication circuits including the antennas, and is preferably useful for particularly in quasi-millimeter wave/millimeter wave band radio communication.

### REFERENCE SIGNS LIST

10 multilayer ceramic body
10a upper surface
10b lower surface
10c first portion
10d second portion
11, 11′ planar antenna
12 interconnection circuit
15 hollow space
15′ through opening
15a upper surface
15b lower surface
21, 22, 23 electrode
31 radiation conductor
31′, 32′, 33′, 35′ conductive paste pattern
32 ground conductor
33 passive component pattern
34 conductive via
34′ conductive paste
35 interconnection pattern
37 power supply line
38 slot
39 grounded conductor
41 solder bump
42 passive component
43 active component
51 circuit substrate
52 electrode
53 molding resin
60 carrier film
61 ceramic green sheet
62, 62′ via hole (through hole)
63 paste
65 conductive paste
65′ conductive via
71, 72, 73, 74 ceramic green sheet
75 green sheet laminate
81, 81′ through hole
82 hollow portion
101, 102 co-fired ceramic substrate
103 radio communication module
110, 110′, 110″, 111 ceramic layer
111a, 115a upper surface
111b, 115b lower surface
115, 116, 117, 118 low-dielectric-constant region

1. A planar antenna comprising:
a multilayer ceramic body having an upper surface and a lower surface, and including a plurality of ceramic layers stacked together;
at least one radiation conductor positioned at one of interfaces between the plurality of ceramic layers in the multilayer ceramic body or on the upper surface of the multilayer ceramic body;
a ground conductor positioned at another one of the interfaces between the plurality of ceramic layers in the multilayer ceramic body or on the lower surface of the multilayer ceramic body; and
a low-dielectric-constant region positioned in the multilayer ceramic body between the radiation conductor and the ground conductor, and having a plurality of hollow portions.

2. The planar antenna of claim 1, wherein in a top view the multilayer ceramic body, an outer edge of the low-dielectric-constant region surrounds the entire radiation conductor.

3. The planar antenna of claim 1, wherein in a top view the multilayer ceramic body, an outer edge of the ground conductor surrounds the entire radiation conductor.

4. The planar antenna of claim 1, wherein the radiation conductor is positioned on the upper surface of the multilayer ceramic body.

5. The planar antenna of claim 1, wherein the plurality of hollow portions are a plurality of through holes provided in at least one ceramic layer of the plurality of ceramic layers.

6. The planar antenna of claim 1, wherein the plurality of hollow portions are a plurality of through holes provided in each of two or more adjacent ceramic layers of the plurality of ceramic layers, and
the plurality of through holes formed in the two or more respective ceramic layers are aligned in a stacking direction of the two or more ceramic layers.

7. The planar antenna of claim 6, wherein the plurality of through holes are arranged in two directions or in a staggered pattern in a plane perpendicular to the stacking direction.

8. The planar antenna of claim 1, wherein the plurality of hollow portions are a plurality of through holes provided in each of two or more adjacent ceramic layers of the plurality of ceramic layers, and positions of the plurality of through holes are different between two adjacent ceramic layers.

9. The planar antenna of claim 1, wherein
the plurality of hollow portions are a plurality of through holes provided in each of two or more ceramic layers of the plurality of ceramic layers, and
a ceramic layer in which a through hole is not formed is positioned between the two or more ceramic layers.

10. The planar antenna of claim 1, wherein the plurality of hollow portions are provided in at least one ceramic layer of the plurality of ceramic layer, and are a space that does not penetrate through the ceramic layer.

11. The planar antenna of claim 1, wherein there are a plurality of the radiation conductors.

12. A co-fired ceramic substrate comprising:
a multilayer ceramic body having an upper surface and a lower surface, and including a plurality of ceramic layers stacked together;
at least one radiation conductor positioned at one of interfaces between the plurality of ceramic layers in the multilayer ceramic body or on the upper surface of the multilayer ceramic body;
a ground conductor positioned at another one of the interfaces between the plurality of ceramic layers in the multilayer ceramic body or on the lower surface of the multilayer ceramic body;
a low-dielectric-constant region positioned in the multilayer ceramic body between the radiation conductor and the ground conductor, and having a plurality of hollow portions;
a plurality of conductor patterns positioned at another interface that is between the plurality of ceramic layers and is positioned closer the lower surface than is the radiation conductor; and
a plurality of conductive vias provided in a ceramic layer of the plurality of ceramic layer that is positioned closer to the lower surface than is the radiation conductor,
wherein the radiation conductor, the ground conductor, and a portion of the plurality of ceramic layers positioned between the radiation conductor and the ground conductor form a planar antenna, and
the plurality of conductor patterns and the plurality of conductive vias form a passive component and an interconnect.

13-16. (canceled)

17. The co-fired ceramic substrate of claim 12, wherein the plurality of hollow portions are a plurality of through holes provided in each of two or more adjacent ceramic layers of the plurality of ceramic layers, and
the plurality of through holes formed in the two or more respective ceramic layers are aligned in a stacking direction of the two or more ceramic layers.

18. The co-fired ceramic substrate of claim 17, wherein the plurality of through holes are arranged in two directions or in a staggered pattern in a plane perpendicular to the stacking direction.

19. The co-fired ceramic substrate of claim 12, wherein the plurality of hollow portions are a plurality of through holes provided in each of two or more adjacent ceramic layers of the plurality of ceramic layers, and positions of the plurality of through holes are different between two adjacent ceramic layers.

20. The co-fired ceramic substrate of claim 12, wherein the plurality of hollow portions are a plurality of through holes provided in each of two or more ceramic layers of the plurality of ceramic layers, and
a ceramic layer in which a through hole is not formed is positioned between the two or more ceramic layers.

21. (canceled)

22. A radio communication module comprising:
the co-fired ceramic substrate of claim 12; and
an active component coupled to the plurality of electrodes positioned on the lower surface of the multilayer ceramic body.

23. A method for producing a co-fired ceramic substrate, comprising:
a step (A) of preparing a plurality of ceramic green sheets including a first ceramic green sheet on which a conductive paste pattern of a radiation conductor is disposed, a second ceramic green sheet on which a conductive paste pattern of a ground conductor is disposed, and at least one third ceramic green sheet including a region in which a plurality of through holes are formed;
a step (B) of stacking the plurality of ceramic green sheets together and joining the plurality of ceramic green sheets together by pressing such that the conductive paste pattern of the radiation conductor of the first ceramic green sheet is positioned above or below the region of the at least one third ceramic green sheet, and the at least one third ceramic green sheet is positioned between the first ceramic green sheet and the second ceramic green sheet, to obtain a green sheet laminate; and
a step (C) of heating the green sheet laminate to sinter the green sheet laminate.

24. The method for producing a co-fired ceramic substrate of claim 23, further comprising:
a step of, between the step (A) and the step (B), filling the plurality of through holes of the at least one third ceramic green sheet with a paste containing an organic resin,
wherein in the step (C), the paste containing the organic resin is caused to disappear due to the heating.

25. A method for producing a co-fired ceramic substrate, comprising:
a step (A) of preparing a plurality of ceramic green sheets including a first ceramic green sheet on which a conductive paste pattern of a radiation conductor is disposed, a second ceramic green sheet on which a conductive paste pattern of a ground conductor is disposed, and at least one third ceramic green sheet including a region in which a plurality of microcapsules of an organic material are disposed;
a step (B) of stacking the plurality of ceramic green sheets together and joining the plurality of ceramic green sheets together by pressing such that the conductive paste pattern of the radiation conductor of the first ceramic green sheet is positioned above or below the region of the at least one third ceramic green sheet, and the at least one third ceramic green sheet is positioned between the first ceramic green sheet and the second ceramic green sheet, to obtain a green sheet laminate; and
a step (C) of heating the green sheet laminate to cause a binder and the microcapsules to disappear from the green sheet laminate, and sinter the green sheet laminate.
